(19) United States
(12) Patent Application Publication
(10) Pub. No.: US 2012/0124039 A1
(43) Pub. Date: May 17, 2012

(54) Online Search Based On Geography Tagged Recommendations

(76) Inventors: Thomas Sandholm, Mountain View, CA (US); Bernardo Huberman, Palo Alto, CA (US)

(21) Appl. No.: 13/384,705

(22) PCT Filed: Aug. 11, 2009
(86) PCT No.: PCT/US09/53426

§ 371 Date: Jan. 18, 2012

(51) Int. Cl. G06F 17/30; G06Q 30/06; G06F 15/16

(52) U.S. Cl. 707/724; 705/26.4; 707/E17.014

(57) ABSTRACT

A respective submission is received from each of multiple recommending client network nodes (12, 14). Each of the submissions includes respective recommendation information in association with a respective online document identifier identifying a respective online document and a respective geographic location identifier identifying a respective geographic location. For each of multiple of the received submissions, the recommendation information and the online document identifier are indexed in association with the geographic location identifier. In response to receipt of location information from a searching client network node (12, 14), ones of the online document identifiers that are associated with respective ones of the geographic location identifiers that correspond to the received location information are ascertained. The ascertained ones of the online document identifiers are ranked based on the recommendation information respectively associated with the online document identifiers. A list of the ranked online documents identifiers is provided to the searching client network node (12, 14).

### BACKGROUND

Individuals and organizations are able to access an ever-increasing amount of information that is stored in a wide variety of different network-based databases. For example, the internet provides access to a vast number of databases. Web pages are one of the most common forms of internet content. Web pages are provided by the world-wide web (the “web”), which is an internet service that is made up of server-hosting computers known as “web servers”. A web server stores and distributes web pages, which are hypertext documents that are accessible by web browser client programs. Web pages are transmitted over the internet using the HTTP protocol.

Search engines enable users to search for web page content that is available over the internet. Search engines typically query searchable databases that contain indexed references (i.e., Uniform Resource Locators (URLs)) to web pages and other documents that are accessible over the internet. In addition to URLs, these databases typically include other information relating to the indexed documents, such as keywords, terms occurring in the documents, and brief descriptions of the contents of the documents. The indexed databases relied upon by search engines typically are updated by a search program (e.g., “web crawler,” “spider,” “ant,” “robot,” or “intelligent agent”) that searches for new web pages and other content on the web. New web pages that are located by the search program are summarized and added to the indexed databases.

Search engines allow users to search for documents that are indexed in their respective databases by specifying keywords or logical combinations of keywords. The results of a search query typically are presented in the form of a list of items corresponding to the search query. Each item typically includes a URL for the associated document, a brief description of the content of the document, and the date of the document. The search results typically are ordered in accordance with relevance scores that measure how closely the listed documents correspond to the search query.

### SUMMARY

In one aspect, the invention features a method in accordance with which a respective submission is received from each of multiple recommending client network nodes over a network. Each of the submissions includes respective recommendation information in association with a respective online document identifier identifying a respective online document and a respective geographic location identifier identifying a respective geographic location. For each of multiple of the received submissions, the respective recommendation information and the respective online document identifier are indexed in association with the respective geographic location identifier in a database stored on at least one computer-readable medium. In response to receipt of location information from a searching client network node, ones of the online document identifiers that are associated with respective ones of the geographic location identifiers in the database that correspond to the received location information are ascertained. The ascertained ones of the online document identifiers are ranked based on the recommendation information respectively associated with the online document identifiers. A list of the ranked online documents identifiers is provided to the searching client network node over the network.

The invention also features apparatus operable to implement the method described above and computer-readable media storing computer-readable instructions causing a computer to implement the method described above.

### DESCRIPTION OF DRAWINGS

FIG. 1 is a diagrammatic view of an embodiment of a network communication environment that includes a first client network node, a second client network node, and an online document search system.

FIG. 2 is a flow diagram of an embodiment of a method of visualizing realtime networked communications on a client network node.

FIG. 3 is a block diagram of an embodiment of a network node.

FIG. 4 is a diagrammatic view of an embodiment of a client user interface.

FIG. 5 is a diagrammatic view of an embodiment of a client user interface.

FIG. 6 is a diagrammatic view of an embodiment of a client user interface.

FIG. 7 is a diagrammatic view of an embodiment of a client user interface.

FIG. 8 is a flow diagram of an embodiment of a method of processing user-generated comments.

FIG. 9 is a diagrammatic view of an embodiment of an online document search based usage model.

FIG. 10 is a diagrammatic view of an embodiment of an online document search based usage model.

FIG. 11 is a diagrammatic view of an embodiment of an online document search based usage model.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Definition of Terms

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

A “network node” (also referred to simply as a “node”) is a junction or connection point in a communications network. Exemplary network nodes include, but are not limited to, a terminal, a computer, and a network switch. A “server” network node is a host computer on a network that responds to requests for information or service. A “client” network node is a computer on a network that requests information or service from a server. A “network connection” is a link between two communicating network nodes. The term “recommending client network node” refers to a client network node that submits a geography tagged recommendation to an online document search system. The term “searching client network node” refers to a client network node that submits geography tagged search requests to an online document search system and receives online document recommendations from the online document search system.

A “database” is an organized collection of records that are presented in a standardized format that can be searched by computers. A database may be stored on a single computer-readable data storage medium on a single computer or it may be distributed across multiple computer-readable data storage media on one or more computers.

The term “online document” refers to any type of resource of information that is accessible over a network using a unique reference (e.g., a uniform resource identifier (URI), such as or a uniform resource locator (URL)). Examples of online documents include an electronic mail message, a web page, a business listing, a data file, a news group posting, a blog, a wiki, a web advertisement. A web page (e.g., an HTML or XHTML web page) is accessible over the world wide web through a web browser. A web page typically contains information, graphics, and hyperlinks to other web pages and files. A “web site” includes one or more web pages that are made available through what appears to users as a single web server.

The term “click” refers to the act or operation of entering or inputting an execution command (e.g., clicking the left computer mouse button).

A “link” refers to an object (e.g., a piece of text, an image or an area of an image) that loads a hypertext link reference into a target window when selected. A link typically includes an identifier or connection handle (e.g., URI) that can be used to establish a network connection with a resource or service on a network node.

The term “geographic location identifier” refers to geographical identification metadata from which a particular geographic location can be identified. Exemplary geographic location identifiers include latitude and longitude coordinates, place names, and non-coordinate based geographical identifiers (e.g., a street address) from which the associated geographic coordinates can be determined.

As used herein, the term “includes” means includes but not limited to, the term “including” means including but not limited to. The term “based on” means based at least in part on.

### II. Introduction

The embodiments that are described herein provide systems and methods of searching for online documents based on geography tagged recommendations. These embodiments enable users to recommend online documents to others in connection with respective geographic locations and optionally with respective channels corresponding to categories respectively assigned to the online documents. A subscribing user may be presented with a ranked list of the most popular online documents within a particular geographic location and optionally on a particular channel that is selected by the user.

In some embodiments, the number of recommendations that a particular user may make within a time span is limited by the amount of credit that the user currently has available. Recommendation credits (or tickets) may be granted or purchased and used to increase prominence of an online document in connection with a geographic location.

Some embodiments allow users to submit user-generated comments in association with respective geographic location identifiers that identify respective geographic locations. This feature allows a user to submit a user-generated comment for any online document and any point of interest (e.g., the location of a business or other location); even those points of interest that currently do not have an online presence.

In this way, users may identify online documents that may be popular in connection with particular geographic locations without having any explicit or deterministic ties to these locations. These embodiments also accommodate changes in such ties over time, for example, due to individual and collective events and preferences. These tacit ties embody information that traditional search engines cannot leverage easily. Imagine someone visiting a location for the first time, and discovering that the web search tools and services (e.g., classified ads, map services, and hotel booking services) she is familiar with render very poor results or quality of service for the new location. These services may or may not be located in the areas where they provide good service. The embodiments described herein overcome this problem by enabling consumer-driven geography tagged recommendations and providing online search results based on these recommendations. Although searches for online documents that are geo-tagged with local information may be performed, the information flow resulting from such searches can be overwhelming despite the geographic context. The embodiments described herein overcome this problem by enabling additional situational filtering based on crowdsourced recommendations and optional channel associations.

Embodiments that are described herein also enable service providers to compete and invest in increasing the prominence of their web sites in local information markets without having to compete with larger service providers in the global market. These embodiments enable the promotion of localized small-scale businesses by creating information markets and ad-bidding that can be entered on a very fine-grained local level. For example, a search for web sites within a few meters of a particular location may give prominence to a small local business or service that otherwise might be undiscoverable in searches with larger search scopes. These embodiments also enable larger businesses and service providers to optimize their site advertisement by distributing their investment over regions with the best historical return on investment.

### III. Overview

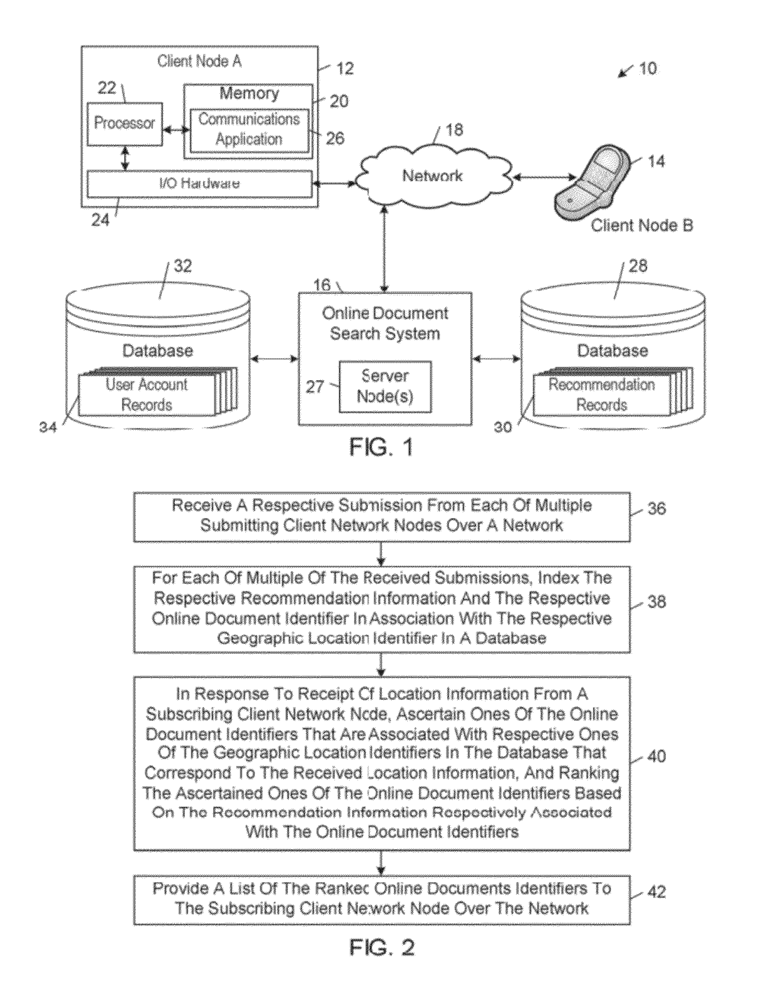

FIG. 1 shows an embodiment of an exemplary network communications environment 10 that includes a first client network node 12 (Client Node A), a second client network node 14 (Client Network Node B), and an online document search system 16 that are interconnected by a network 18. The first client network node 12 includes a computer-readable memory 20, a processor 22, and input/output (I/O) hardware 24 (including a display). The processor 22 executes at least one communications application 26 that is stored in the memory 20. The second client network node 14 typically is configured in substantially the same way as the first client network node 12.

The communications applications 26 operating on the first and second client network nodes 12, 14 communicate with the online document search system 16. The communications application 26 typically operates on a client network node that includes software and hardware resources which, together with administrative policies, user preferences, and other settings, define a local configuration that influences the administration of connections with other network nodes. The communications applications 26 also provide respective interfaces for receiving commands from the communicants. In addition, the communication applications handle the submission of recommendations from the client network nodes 12, 14 to the online document search system 16 and the presentation of search results from the online document search system 16 to the client network nodes 12, 14. In some embodiments, the communication applications 26 are implemented by web browser applications that respectively include extensions or plugins that handle communications with the online document search system 16.

The online document search system 16 typically includes one or more server nodes 27 that provide network infrastructure services that cooperate with the communications applications 26 in the process of establishing and administering network connections with the client nodes 12, 14. The network infrastructure services may run on a single network node or may be distributed across multiple network nodes. The network infrastructure services typically run on one or more dedicated network nodes (e.g., a server computer or a network device that performs one or more edge services, such as routing and switching).

The online document search system 16 maintains a database 28 that contains records 30 of geo-tagged online document recommendations that were received from the client network nodes 12, 14. Each recommendation record 30 describes an association between a respective online document identifier that identifies a respective online document, recommendation information (e.g., an amount of credit allocated to the online document), and a geographic location identifier that identifies a respective geographic location. Each recommendation record 30 also optionally may include (i) a respective user identifier that identifiers a user of the respective client network node that sent a submission from which the recommendation was derived, (ii) a respective channel identifier that identifies a respective category that is assigned to the associated online document, and (iii) a reference to a related URL, which may be used to bring up recommendations/notes when that URL is opened in a browser application.

In some embodiments, the online document search system 16 additionally maintains a second database 32 that contains records 34 of user accounts. The user account records 34 typically store contact information, an amount of recommendation credit that currently is available for submitting recommendations, and other information relating to the respective users of the client network nodes 12, 14.

The network 18 may include any of a local area network (LAN), a metropolitan area network (MAN), and a wide area network (WAN) (e.g., the internet). The network 18 typically includes a number of different computing platforms and transport facilities that support the transmission of a wide variety of different media types (e.g., text, voice, audio, and video) between network nodes.

FIG. 2 shows an embodiment of a method that is implemented by the online document search system 16. In accordance with this embodiment, the online document search system 16 receives a respective submission from each of multiple recommending client network nodes over a network (FIG. 2, block 36). Each of the submissions includes respective recommendation information in association with a respective online document identifier identifying a respective online document and a respective geographic location identifier identifying a respective geographic location. For each of multiple of the received submissions, the online document search system 16 indexes the respective recommendation information and the respective online document identifier in association with the respective geographic location identifier in a database stored on at least one computer-readable medium (FIG. 2, block 38). In response to receipt of location information from a searching client network node, the online document search system 16 ascertains ones of the online document identifiers that are associated with respective ones of the geographic location identifiers in the database that correspond to the received location information, and ranks the ascertained ones of the online document identifiers based on the recommendation information respectively associated with the online document identifiers (FIG. 2, block 40). The online document search system 16 provides a list of the ranked online documents identifiers to the searching client network node over the network (FIG. 2, block 42).

### IV. Embodiments of Online Document Search Based on Geography Tagged Recommendations

A. Operating Environment

In some embodiments, the one or more server network nodes 27 of the online document search system 16 are implemented by respective general-purpose computer systems each of which typically executes one or more server software applications.

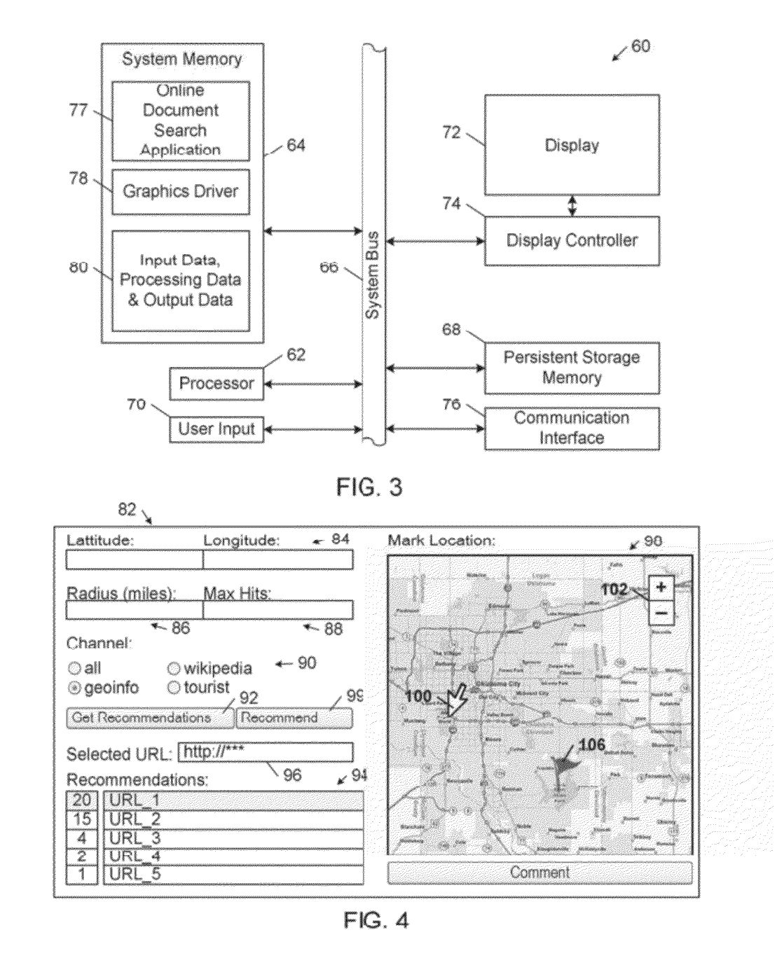

FIG. 3 shows an embodiment 60 of the server network node 27 that includes a processor 62 (e.g., a CPU), a system memory 64, and a system bus 66 that couples processing unit 62 to the various components of the server network node 60. The processor 62 typically includes one or more processors, each of which may be in the form of any one of various commercially available processors. The system memory 64 typically includes a read only memory (ROM) that stores a basic input/output system (BIOS) that contains start-up routines for the server network node 60 and a random access memory (RAM). The system bus 66 may be a memory bus, a peripheral bus or a local bus, and may be compatible with any of a variety of bus protocols, including PCI, VESA, Microchannel, ISA, and EISA. The server network node 60 also includes a persistent storage memory 68 (e.g., a hard drive, a floppy drive, a CD ROM drive, magnetic tape drives, flash memory devices, and digital video disks) that is connected to the system bus 66 and contains one or more computer-readable media disks that provide non-volatile or persistent storage for data, data structures and computer-executable instructions.

A user may interact (e.g., enter commands or data) with the computer 60 using one or more input devices 70 (e.g., a keyboard, a computer mouse, a microphone, joystick, and touch pad). Information may be presented through a graphical user interface (GUI) that is displayed to the user on a display monitor 72, which is controlled by a display controller 74. The server network node 60 also typically includes peripheral output devices, such as speakers and a printer. One or more remote computers may be connected to the server network node 60 through a network interface card (NIC) 76.

As shown in FIG. 3, the system memory 64 also stores an online document search application 77, and a GUI driver 78, and input data, processing data, and output data 80. The online document search application 77 is executed by the server network node 60 in order to implement the functionality of the online document search system 16. In some embodiments, the online document search application 77 interfaces with the GUI driver 78 and the user input 70 to control the operation of the online document search system.

Each of the client network nodes 12, 14 typically includes one or more discrete data processing components, each of which may be in the form of any one of various commercially available data processing chips. Each client network node 12, 14 is not limited to a specific hardware or software configuration, but rather it may be implemented in any computing or processing environment, including in digital electronic circuitry or in computer hardware, firmware, device driver, or software. In some implementations, the client network nodes 12, 14 are implemented by any one of a wide variety of digital and analog electronic devices, including desktop and workstation computers, printers, scanners, and portable electronic devices (e.g., mobile phones, laptop and notebook computers, personal digital assistants, cordless telephones, digital still image cameras, digital video cameras, micro-projectors, multimedia players, game controllers, and pagers). In some embodiments, each client network node 12, 14 executes process instructions (e.g., machine-readable code, such as computer software) for implementing the methods that are executed by the embodiments of the communications application 26. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

Embodiments of the methods performed by the communications applications 26 may be implemented by one or more discrete modules (or data processing components) that are not limited to any particular hardware, firmware, or software configuration. In some embodiments, the functionalities of the modules are combined into a single data processing component. In some embodiments, the respective functionalities of each of one or more of the modules are performed by a respective set of multiple data processing components. The various modules of the communications applications 26 may be co-located on a single apparatus or they may be distributed across multiple apparatus; if distributed across multiple apparatus, the modules may communicate with each other over local wired or wireless connections, or they may communicate over global network connections (e.g., communications over the internet).

In some embodiments, the online document search system 16 includes a back-end service that uses dynamic database sharding to partition the data efficiently for scalable geo-location (e.g., find nearby and rank) queries. In these embodiments, recommendations are not allowed span partitions for efficiency. Within the same shard group (i.e., sorted region of shards hosted on the same database server), recommendations are limited by a user-specified radius away from a particular location (e.g., latitude, longitude coordinate) and the total number of hits requested. Both of these have upper limits to fit the display layouts of the client network nodes and to preserve server scalability. A lightweight XML and JSON remote interface is provided to be accessible from a wide range of devices and web browsers. In parallel, the online document search system 16 also runs data-mining and web crawling agents that automatically populates the database 28 with geo and URL data for specific channels in order to maintain a high overall quality even for long tail information items that might be requested by very few users or very rarely. In some embodiments, the online document search system 16 leverages well-proven attention economy, collaborative filtering, and information market research in order to improve the accuracy of the list of ranked online document identifiers that are send to the client network nodes.

B. Submitting Recommendations

As explained above, the online document search system 16 receives a respective submission from each of multiple recommending client network nodes 12, 14 over the network 18 (FIG. 2, block 36). Each of the submissions includes respective recommendation information in association with a respective online document identifier identifying a respective online document and a respective geographic location identifier identifying a respective geographic location.

FIG. 4 shows an embodiment of a graphical user interface 82 that is generated by the communications applications 26 and displayed on the display of the client network nodes 12, 14. The graphical user interface 82 includes a geographic coordinates display area 84, a geographic range input area 86, an input area 88 for specifying a maximum number of search results, a channel selection area 90, a “Get Recommendations” button 92 for requesting online document recommendations from the online document search system 16, a “Recommendations” display area 94, a “Selected URL” display area 96, and a map area 98. The graphical user interface 82 also includes a “Recommend” button 99 that allows the user to submit a recommendation for the selected online document identifier appearing in the “Selected URL” display area 96.

The geographic coordinates display area 84 displays the latitude and longitude coordinates of a particular location. The latitude and longitude coordinates may be input by the user (e.g., by manually typing into the associated boxes, or by using a pointer 100 to select a location on a map that is displayed in the map area 98) or they may be obtained automatically by searching by address identifiers (e.g., street, zip, city etc) or obtaining a reading from a location sensor (e.g., a built-in GPS receiver) that is associated with the client network node. These geographic coordinates collectively constitute a geographic location identifier that identifies a particular location to the online document search system 16. The geographic range input area 86 allows the user to identify a target geographic location by specifying a value of a radius of a circular region that is centered at the latitude and longitude coordinates in the geographic coordinates display area 84. In other embodiments, the user may identify a target geographic location in other ways. For example, the user may use the pointer 100 to draw a rectangular boundary of the target geographic location on the map that is displayed in the map area 98. Alternatively, the user may use the magnification controller 102 to select a magnification level of the map in the map area 98 such that the entire geographic region appearing in the map area 98 corresponds to the target geographic location.

The user selects one of the channels (e.g., “all”, “geoinfo”, “wikipedia”, and “tourist”) in the channel selection area 90 to specify a channel that will be associated with a recommendation or that will be used by the online document search system 16 to restrict the online document search to only those online documents that are associated with channel identifiers that correspond to the specified channel.

In some embodiments, users are given the option to limit online document searches to only those online documents that are associated with recommendations from a target group of user identifiers. The target group of user identifiers may, for example, consist of the user identifiers for the user's friends, the user's family members, or the user's co-workers. The target group also may be used to allow self-filtering to provide a personal bookmarking service. The online document search system 16 typically stores the identified target groups in the user account records 34 in the database 32.

The user selects the “Get Recommendations” button 92 to submit a request for online document recommendations from the online document search system 16. In response to the receipt of the location information (e.g., the geographic coordinates and the geographic range information) from a searching client network node, the online document search system 16 identifies ones of the online document identifiers that are associated with respective ones of the geographic location identifiers in the database that correspond to the received location information. If a target channel is specified by the user, the online document search system 16 additionally filters the online document identifiers by selecting only those online document identifiers that are associated with channel identifiers that match the target channel identifier. If a target set of user identifiers is specified by the user, the online document search system 16 additionally filters the online document identifiers by selecting only those online document identifiers that are associated with user identifiers that match any of the specified target user identifiers.

The online document search system 16 ranks the identified ones of the online document identifiers based on the recommendation information that respectively is associated with the online document identifiers. In this process, the online document search system 16 typically aggregates the credits that are allocated to each of the online document identifiers. If a target set of user identifiers is specified by the user, the online document search system 16 determines the rankings based on only the recommendation information received from the specified target set of user identifiers.

The online document search system 16 returns a list of the ranked online documents identifiers (up to the maximum number specified in the input area 88) to the searching client network node. The ranked list of online document identifiers is displayed in the “Recommendations” display area 94 of the graphical user interface 82. Each of the online document identifiers (i.e., URL_1, . . . , URL_5) is presented in association with a respective ranking (i.e., 20, 15, 4, 2, 1) that was determined by the online document search system 16 based on the recommendations that were received for the corresponding online documents. In some embodiments, the online document search system 16 also returns other metadata, such as title and sample and average geographic coordinates associated with the online document identifiers to be returned in response to user queries.

In response to the selection of one of the online document identifiers (e.g., URL_1) in the “Recommendations” display area 94, the communications application 26 copies the selected identifier into the “Selected URL” display area 96 and marks (e.g., with a flag icon 106) the location of map in the map area 98 that corresponds to the geographic location identifier that is associated with the selected online document identifier. In some embodiments, the online document search system returns the average of the geographic coordinates associated with the online document identifiers in the “Recommendations” display area 94, and the communications application 26 displays and maps the average location.

When a user wishes to recommend a particular online document, the user identifies the online document identifier to the communications application 26 simply by browsing to the particular online document with a browser application.

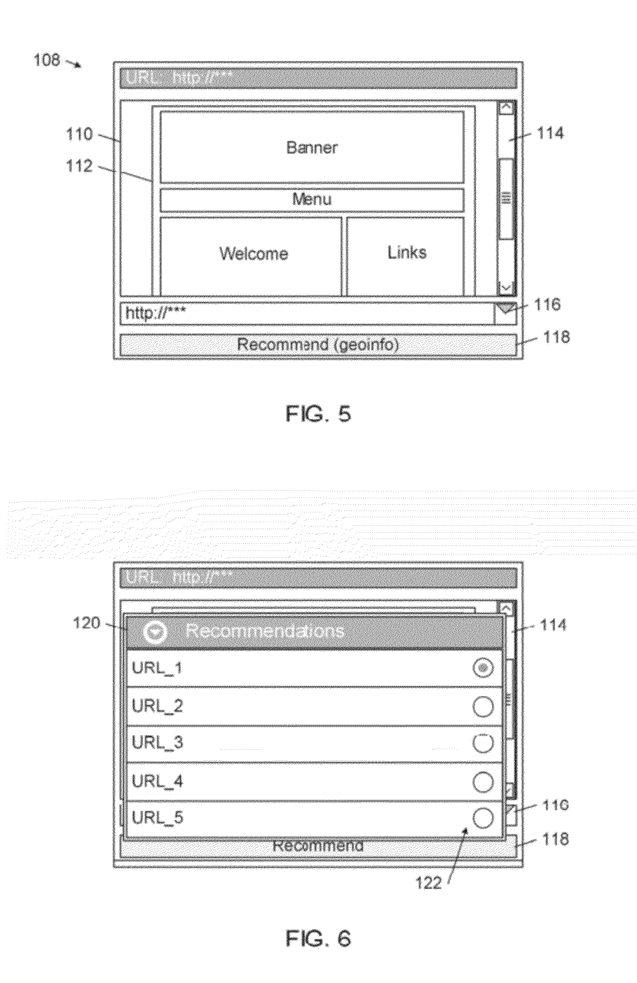

Referring to FIG. 5, the communications application 26 also opens up a graphical user interface 108 that includes a browser window 110, which displays a graphical representation 112 of the online document that corresponds to the selected online document identifier. The browser window 110 optionally includes a scroll bar 114 that allows the user to scroll through the online document representation 112. The interface 108 additionally includes a recommendations control 116 and a “Recommend” button 118, which includes a label (e.g., “geoinfo”) that identifies the current channel that was selected by the user. In some embodiments, the graphical user interface 108 also includes a “Channel” button which causes the communications application 26 to submit to the online document search system 16 a search on the most popular channels in the current geo-location. This information gives the user a hint what it makes sense to filter on.

Referring to FIG. 6, in response to user selection of the recommendations control 116, the communications application 26 opens a separate “Recommendations” window 120 that presents the ranked list of online document identifiers that was received from the online document search system 16. The user may select one of the presented online document identifier to browse by selecting the associated one of the radio control buttons 122 in the recommendations window 120.

In response to user selection of the “Recommend” button 99 in the graphical user interface 82 (FIG. 4) or the “Recommend” button 118 in the graphical user interface 108 (FIG. 5), the communications application prepares a submission and sends the submission to the online document search system 16. The submission includes recommendation information in association with the current location information that is specified in geographic coordinates display area 84 (and optionally includes the geographic range information specified in the input area 88) and the identifier of the currently selected online document identifier. In some embodiments, the recommendation information is specified by a set of recommendation configuration settings, which may be fixed or customizable by the user. The recommendation configuration settings typically include a user identifier that identifies the user and an amount of credit (also referred to as “submission credit”) to allocate for each recommendation. In other embodiments, for each submission, the communications application 26 opens a dialog box that allows the user to specify at least some of the recommendation information that will be transmitted with the submission. The specified recommendation may include, for example, the amount of credit to allocate to the selected online document, and an indication whether the recommendation is for (positive) or against (negative) the selected online document.

In response to receipt of the submission from the client network node, the online document search system 16 indexes the respective recommendation information and the respective online document identifier in association with the respective geographic location identifier in the recommendation records database 28.

C. Submitting Comments

In some embodiments, the online document search system 16 allows users to submit user-generated comments (or notes) in association with respective geographic location identifiers that identify respective geographic locations. This feature allows a user to submit a user-generated comment for any online document and any point of interest (e.g., the location of a business or other location), even those points of interest that currently do not have an online presence (e.g., they are not associated with any online document, such as a web page). The geo-tagged comments are hosted by the online document search system 16, which allows the comments to be treated in the same way as other online documents by the online document search system 16. For example, users of the client network nodes 12, 14 can submit recommendations for comments and the comments can be filtered based on channel selections and identification of target groups of user identifiers (e.g., friends).

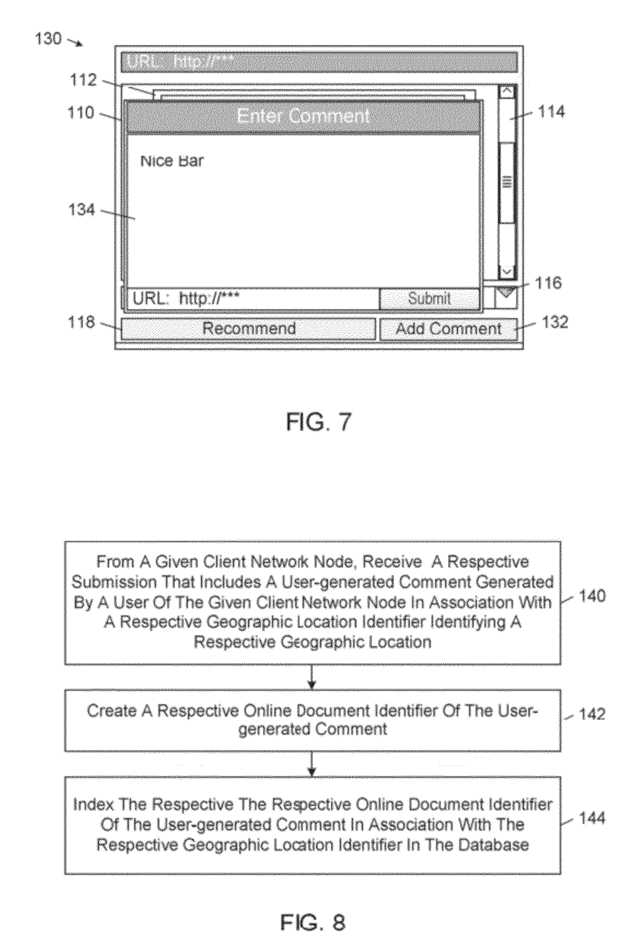

FIG. 7 shows an embodiment 130 of the browser window 82 that additionally includes an “Add Comment” button 132. In response to user selection of the “Add Comment” button 132, the communications application 26 opens an “Enter Comment” window 134 that allows the user to enter a comment (e.g., “Nice Bar”). In response to user selection of a “Submit” button in the “Enter Comment” window 132, the communications application 26 prepares a comment submission that includes the user-generated comment along with the user identifier that identifies the user, a geographic location identifier that identifies the currently selected location, and optionally includes an online document identifier (if one is specified).

FIG. 8 shows an embodiment of a method that is implemented by the online document search system 16. In accordance with this method, the online document search system 16 receives a respective submission from a given client network node (FIG. 8, block 140). The submission includes a user-generated comment that is generated by a user of the given client network node in association with a respective geographic location identifier identifying a respective geographic location. The online document search system 16 creates a respective online document identifier of the user-generated comment (FIG. 8, block 142). The online document search system 16 indexes the respective online document identifier of the user-generated comment in association with the respective geographic location identifier in the database (FIG. 8, block 144).

Once a comment has been indexed, the online document search system 16 is able to serve a renderable description of a graphical representation of the user-generated comment in response to receipt of a request from a client network node to view content associated with the online document identifier of the user-generated comment. In some embodiments, when an online document is displayed in the browser window, the most popular comments that are associated with that online document in the current geo-location also will be displayed. In addition, the online document search system 16 is able to receive a respective submission from a particular client network node in connection the hosted comment. The submission can include, for example, respective recommendation information in association with the respective online document identifier identifying the user-generated comment and a respective geographic location identifier identifying a respective geographic location. In response to the receipt of such a submission, the online document search system 16 indexes the respective recommendation information and the respective online document identifier of the user-generated comment in association with the respective geographic location identifier in the database 28.

D. Credit Based Recommendation and Search

In some embodiments, the number of recommendations that a particular user may make within a time span is limited by the amount of credit that the user currently has available. Recommendation credits (or tickets) may be granted or purchased and used to increase prominence of an online document in connection with a geographic location. In these embodiments, users are periodically issued credit (which also may be referred to as “currency”) in the form of granted or purchased tickets that allows them to recommend a certain number of online documents within a specified time window.

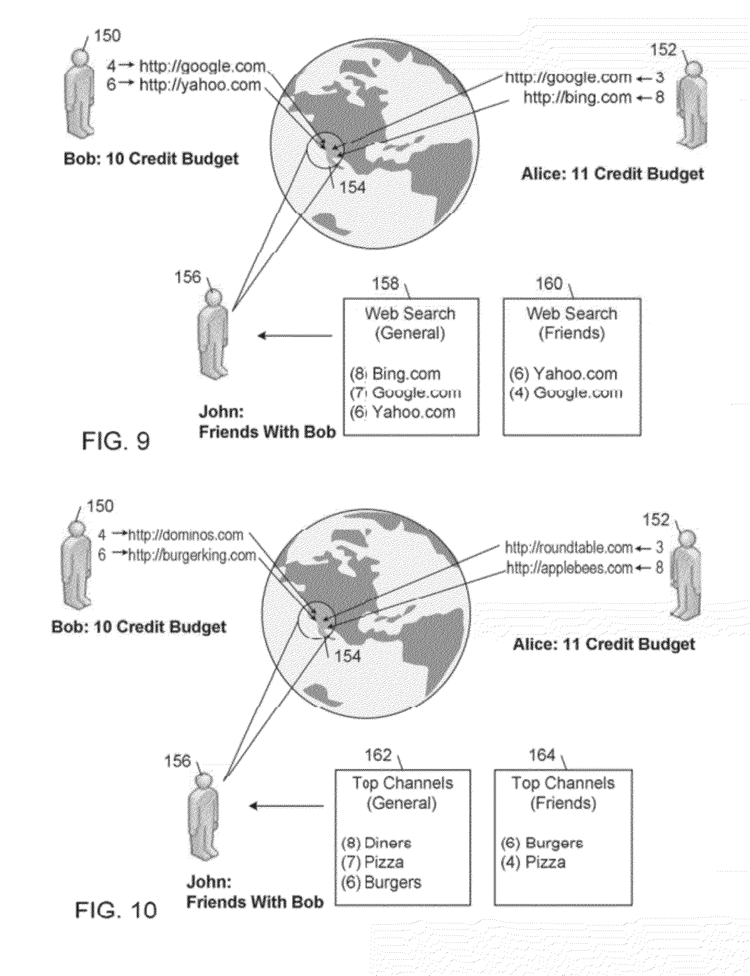

FIG. 9 shows an embodiment of an online document search based usage model in which a first user 150 (“Bob”) and a second user 152 (“Alice”) both submit recommendations for online documents in association with particular geographic locations within a circular geographic region 154, and a third user 156 (“John”) submits requests for online document identifiers that are associated with recommendations in the geographic region 154. In this example, Bob submits a 4-credit recommendation for the online identifier http://google.com and a 6-credit recommendation for the online identifier http://yahoo.com. Alice submits a 3-credit recommendation for the online identifier http://google.com and an 8-credit recommendation for the online identifier http://bing.com. John submits two search requests. The first search request is a general search request for all the web sites that are associated with the geographic region 154. In response to the first search request, the online document search system 16 returns a ranked list 158 of the most popular (i.e., highest aggregated credit score) online document identifiers (URLs in the illustrated example) that are associated with the geographic region 154. The second search request is a friends-filtered search request for the web sites that are associated with the geographic region 154 and are recommended by John's friends (i.e., Bob). In response to the second search request, the online document search system 16 returns a ranked list 158 of the most popular (i.e., highest aggregated credit score) online document identifiers (URLs in the illustrated example) that are associated with the geographic region 154 and are recommended by Bob.

FIG. 10 is a diagrammatic view of an embodiment of an online document search based usage model in which the first user 150 (“Bob”) and the second user 152 (“Alice”) both submit recommendations for online documents associated with particular restaurants located within the circular geographic region 154, and the third user 156 (“John”) submits requests for online document identifiers that are associated with recommendations in the geographic region 154. In this example, Bob submits a 4-credit recommendation for the online identifier http://dominos.com in association with the “pizza” channel and a 6-credit recommendation for the online identifier http://burgerking.com in association with the “burgers” channel. Alice submits a 3-credit recommendation for the online identifier http://rountable.com in association with the “pizza” channel and an 8-credit recommendation for the online identifier http://applebees.com in association with the “diners” channel. John submits two search requests. The first search request is a general search request for the most popular channels that are associated with the geographic region 154. In response to the first search request, the online document search system 16 returns a ranked list 162 of the most popular (i.e., highest aggregated credit score) channels that are associated with the geographic region 154. The second search request is a friends-filtered search request for the most popular channels that are associated with the geographic region 154 and are recommended by John's friends (i.e., Bob). In response to the second search request, the online document search system 16 returns a ranked list 164 of the most popular (i.e., highest aggregated credit score) channels that are associated with the geographic region 154 and are recommended by Bob.

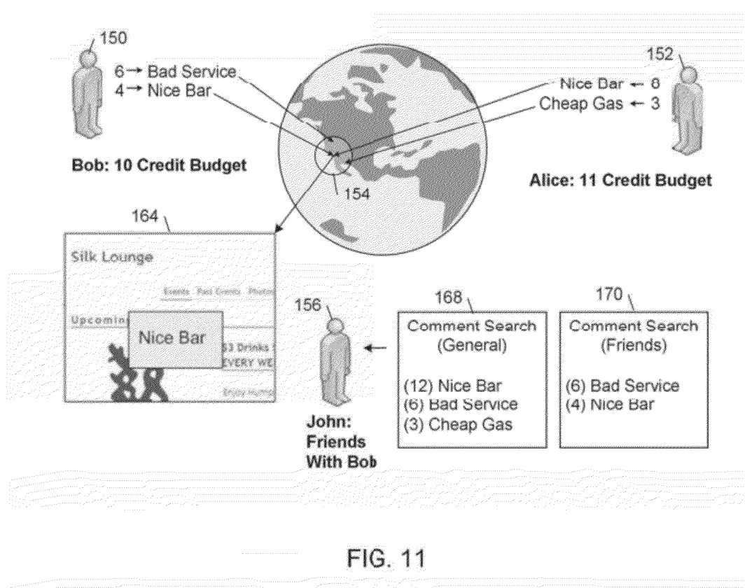

FIG. 11 is a diagrammatic view of an embodiment of an online document search based usage model in which the first user 150 (“Bob”) and the second user 152 (“Alice”) both submit comments for online documents associated with particular businesses that are located within the circular geographic region 154, and the third user 156 (“John”) submits requests for online document identifiers that are associated with recommendations in the geographic region 154. In this example, Bob submits a 6-credit comment for an online identifier that is associated with a web page 166 for the “Silk Lounge” and a 4-credit comment for a second online identifier. Alice submits an 8-credit comment for the online identifier that is associated with the web page 166 for the “Silk Lounge” and a 3-credit comment for a third online identifier. John submits two search requests. The first search request is a general search request for all the comments that are associated with the geographic region 154. In response to the first search request, the online document search system 16 returns a ranked list 168 of the most popular (i.e., highest aggregated credit score) comments that are associated with the geographic region 154. The second search request is a friends-filtered search request for the comments that are associated with the geographic region 154 and are recommended by John's friends (i.e., Bob). In response to the second search request, the online document search system 16 returns a ranked list 170 of the most popular (i.e., highest aggregated credit score) comments that are associated with the geographic region 154 and are recommended by Bob. As shown in FIG. 11, when Bob views the web page 164 that is associated with the “Nice Bar” comment in a web browser. In addition to viewing the web page 164, Bob also is able to see a graphical representation of the most popular comments that are associated with the web page 164; in this case, the only (hence, most popular) comment is the “Nice Bar” comment.

### V. Conclusion

The embodiments that are described herein provide systems and methods of searching for online documents based on geography tagged recommendations. These embodiments enable users to recommend online documents to others in connection with respective geographic locations and optionally with respective channels corresponding to categories respectively assigned to the online documents. A subscribing user may be presented with ranked list of the most popular online documents within a particular geographic location and optionally on a particular channel that is selected by the user.

Other embodiments are within the scope of the claims.

1. A method, comprising:
receiving a respective submission from each of multiple recommending client network nodes over a network, wherein each of the submissions comprises respective recommendation information in association with a respective online document identifier identifying a respective online document and a respective geographic location identifier identifying a respective geographic location;
for each of multiple of the received submissions, indexing the respective recommendation information and the respective online document identifier in association with the respective geographic location identifier in a database stored on at least one computer-readable medium;
in response to receipt of location information from a searching client network node, ascertaining ones of the online document identifiers that are associated with respective ones of the geographic location identifiers in the database that correspond to the received location information, and ranking the ascertained ones of the online document identifiers based on the recommendation information respectively associated with the online document identifiers; and
providing a list of the ranked online documents identifiers to the searching client network node over the network.

2. The method of claim 1, wherein the receiving comprises receiving each of the submissions in connection with a user command to send the submission while a web browser is presenting a document that is identified by the respective document identifier on the respective client network node.

3. The method of claim 1, wherein: each of the submissions comprises a respective user identifier identifying a user of the respective client network node; the indexing comprises indexing the respective user identifier in association with the respective recommendation information, the respective online document identifier, and the respective geographic location identifier in the database; and the ascertaining comprises ascertaining ones of the online document identifiers that are associated with one or more user identifiers in the database that (i) match one or more target user identifiers associated with a user identifier received from the searching client network node and (ii) are associated with respective ones of the geographic location identifiers in the database that correspond to the received location information.

4. The method of claim 1, wherein: each of the submissions comprises a respective channel identifier identifying a category assigned to the respective online document; the indexing comprises indexing the respective channel identifier in association with the respective recommendation information, the respective online document identifier, and the respective graphic location identifier in the database; and the ascertaining comprises ascertaining ones of the online document identifiers that are associated with channel identifiers that match a target channel identifier received from the searching client network node and that are associated with respective ones of the geographic location identifiers in the database that correspond to the received location information.

5. The method of claim 1, wherein each of the submissions comprises a respective user identifier identifying a user of the respective client network node; and further comprising, in response to receipt of each submission, determining an amount of submission credit that currently is associated with the respective user identifier, accepting the submission for indexing in response to a determination that there is sufficient credit associated with the respective user identifier, and rejecting the submission for indexing in response to a determination that there is insufficient credit associated with the respective user identifier.

6. The method of claim 5, further comprising sending an offer to purchase additional credit to a respective one of the client nodes that submitted a respective submission that was rejected.

7. The method of claim 1, wherein at least one of the submissions comprises respective recommendation information in association with a respective uniform resource locator (URL) identifying a respective web page.

8. The method of claim 1, further comprising:
from a given client network node, receiving a respective submission comprising a user-generated comment generated by a user of the given client network node in association with a respective geographic location identifier identifying a respective geographic location;
creating a respective online document identifier of the user-generated comment; and
indexing the respective online document identifier of the user-generated comment in association with the respective geographic location identifier in the database.

9. The method of claim 8, further comprising serving a renderable description of a graphical representation of the user-generated comment in response to receipt of a request from a client network node to view content associated with the online document identifier of the user-generated comment.

10. The method of claim 8, further comprising, from a particular client network node, receiving a respective submission comprising respective recommendation information in association with the respective online document identifier identifying the user-generated comment and a respective geographic location identifier identifying a respective geographic location; and
wherein the indexing comprises indexing the respective recommendation information and the respective online document identifier of the user-generated comment in association with the respective geographic location identifier in the database.

11. Apparatus comprising:
a computer-readable medium storing computer-readable instructions; and
a data processor coupled to the computer-readable medium, operable to execute the instructions, and based at least in part on the execution of the instructions operable to perform operations comprising
receiving a respective submission from each of multiple recommending client network nodes over a network, wherein each of the submissions comprises respective recommendation information in association with a respective online document identifier identifying a respective online document and a respective geographic location identifier identifying a respective geographic location,
for each of multiple of the received submissions, indexing the respective recommendation information and the respective online document identifier in association with the respective geographic location identifier in a database stored on at least one computer-readable medium,
in response to receipt of location information from a searching client network node, ascertaining ones of the online document identifiers that are associated with respective ones of the geographic location identifiers in the database that correspond to the received location information, and ranking the ascertained ones of the online document identifiers based on the recommendation information respectively associated with the online document identifiers, and
providing a list of the ranked online documents identifiers to the searching client network node over the network.

12. The apparatus of claim 11, wherein: each of the submissions comprises a respective user identifier identifying a user of the respective client network node; in the indexing the data processor is operable to perform operations comprising indexing the respective user identifier in association with the respective recommendation information, the respective online document identifier, and the respective graphic location identifier in the database; and in the ascertaining the data processor is operable to perform operations comprising ascertaining ones of the online document identifiers that are associated with one or more user identifiers in the database that (i) match one or more target user identifiers associated with a user identifier received from the searching client network node and (ii) are associated with respective ones of the geographic location identifiers in the database that correspond to the received location information.

13. The apparatus of claim 11, wherein: each of the submissions comprises a respective channel identifier identifying a category assigned to the respective online document; in the indexing the data processor is operable to perform operations comprising indexing the respective channel identifier in association with the respective recommendation information, the respective online document identifier, and the respective graphic location identifier in the database; and in the ascertaining the data processor is operable to perform operations comprising ascertaining ones of the online document identifiers that are associated with channel identifiers that match a target channel identifier received from the searching client network node and that are associated with respective ones of the geographic location identifiers in the database that correspond to the received location information.

14. The apparatus of claim 11, wherein each of the submissions comprises a respective user identifier identifying a user of the respective client network node; and the data processor is operable to perform operations comprising, in response to receipt of each submission, determining an amount of submission credit that currently is associated with the respective user identifier, accepting the submission for indexing in response to a determination that there is sufficient credit associated with the respective user identifier, and rejecting the submission for indexing in response to a determination that there is insufficient credit associated with the respective user identifier.

15. The apparatus of claim 11, wherein the data processor is operable to perform operations comprising:
from a given client network node, receiving a respective submission comprising a user-generated comment generated by a user of the given client network node in association with a respective geographic location identifier identifying a respective geographic location;
creating a respective online document identifier of the user-generated comment; and
indexing the respective online document identifier of the user-generated comment in association with the respective geographic location identifier in the database.

16. At least one computer-readable medium having computer-readable program code embodied therein, the computer-readable program code adapted to be executed by a computer to implement a method comprising:
receiving a respective submission from each of multiple recommending client network nodes over a network, wherein each of the submissions comprises respective recommendation information in association with a respective online document identifier identifying a respective online document and a respective geographic location identifier identifying a respective geographic location;
for each of multiple of the received submissions, indexing the respective recommendation information and the respective online document identifier in association with the respective geographic location identifier in a database stored on at least one computer-readable medium;
in response to receipt of location information from a searching client network node, ascertaining ones of the online document identifiers that are associated with respective ones of the geographic location identifiers in the database that correspond to the received location information, and ranking the ascertained ones of the online document identifiers based on the recommendation information respectively associated with the online document identifiers; and
providing a list of the ranked online documents identifiers to the searching client network node over the network.

17. The at least one computer-readable medium of claim 16, wherein: each of the submissions comprises a respective user identifier identifying a user of the respective client network node; the indexing comprises indexing the respective user identifier in association with the respective recommendation information, the respective online document identifier, and the respective graphic location identifier in the database; and the ascertaining comprises ascertaining ones of the online document identifiers that are associated with one or more user identifiers in the database that (i) match one or more target user identifiers associated with a user identifier received from the searching client network node and (ii) are associated with respective ones of the geographic location identifiers in the database that correspond to the received location information.

18. The at least one computer-readable medium of claim 16, wherein: each of the submissions comprises a respective channel identifier identifying a category assigned to the respective online document; the indexing comprises indexing the respective channel identifier in association with the respective recommendation information, the respective online document identifier, and the respective geographic location identifier in the database; and the ascertaining comprises ascertaining ones of the online document identifiers that are associated with channel identifiers that match a target channel identifier received from the searching client network node and that are associated with respective ones of the geographic location identifiers in the database that correspond to the received location information.

19. The at least one computer-readable medium of claim 16, wherein each of the submissions comprises a respective user identifier identifying a user of the respective client network node; and further comprising, in response to receipt of each submission, determining an amount of submission credit that currently is associated with the respective user identifier, accepting the submission for indexing in response to a determination that there is sufficient credit associated with the respective user identifier, and rejecting the submission for indexing in response to a determination that there is insufficient credit associated with the respective user identifier.

20. The at least one computer-readable medium of claim 16, further comprising:
from a given client network node, receiving a respective submission comprising a user-generated comment generated by a user of the given client network node in association with a respective geographic location identifier identifying a respective geographic location;
creating a respective online document identifier of the user-generated comment; and
indexing the respective online document identifier of the user-generated comment in association with the respective geographic location identifier in the database.
